(19) United States
(12) Patent Application Publication
(10) Pub. No.: US 2009/0176422 A1
(43) Pub. Date: Jul. 9, 2009

(54) MEMBRANE ENCAPSULATED FIBER AND METHOD FOR PRODUCING SAME

(76) Inventor: Gilbert Patrick, Kings Mountain, NC (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/404,549

(22) Filed: Mar. 16, 2009

Related U.S. Application Data
(63) Continuation-in-part of application No. 11/733,912, filed on Apr. 11, 2007.
(60) Provisional application No. 60/862,673, filed on Oct. 24, 2006.

(51) Int. Cl. D03D 9/00; B32B 5/02; D03D 15/00; D04H 5/00; D04H 3/16; D04H 1/46

(52) U.S. Cl. 442/1; 428/375; 442/181; 442/327; 442/401; 442/402

(57) ABSTRACT

This invention generally relates to the production of a composite yarn or non-woven strand wherein a core of super absorbent polymer fibers (SAP's) having a swell factor of approximately 250% and greater are encapsulated by a nonwoven membrane of defined porosity. The membrane is then sealed in a fashion to generally deter or prevent the SAP material from migrating out of the core as water is freely absorbed and desorbed from the composite yarn structure. The strands of yarns or strips of non-woven material are subsequently constructed into an open or unorientated fabric formation. When used as a subterranean fabric, structure or material, the resultant fabric structure retains moisture while permitting normal root growth and allowing excess water to pass through and beneath the fabric while facilitating movement of water from lower levels to the surface.

### CROSS REFERENCE TO RELATED APPLICATIONS

The present patent application is a continuation-in-part of U.S. patent application Ser. No. 11/733,912, filed Apr. 11, 2007, which is a formalization of previously filed, co-pending U.S. provisional patent application Ser. No. 60/862,673, filed Oct. 24, 2006, by the inventors named in the present application. This patent application claims the benefit of the filing date of the cited provisional patent application according to the statutes and rules governing provisional patent applications, particularly USC § 119(e)(1) and 37 CFR § 1.78(a)(4) and (a)(5). The specification and drawings of the provisional patent application are specifically incorporated herein by reference.

### FIELD OF THE INVENTION

This invention generally relates to the production of a composite yarn or non-woven strand and in particular to a composite yarn having a core of super absorbent fibers or polymers (SAP's) encapsulated by a nonwoven membrane of a defined porosity.

### BACKGROUND OF THE INVENTION

Fresh water supplies are becoming increasingly scarce as the world's population continues to increase. Many countries with arid climates and sporadic rainfall experience continual crop failures resulting in chronic food shortages. Most municipalities in developed countries also restrict water usage for lawns as their fresh water supply diminishes.

Systems and materials now have been developed to improve moisture retention and stabilization in soil by adding organic conditioners to help perpetuate plant growth with lower water usage. Such conditioners/stabilizers have been used in many forms, mostly using some type of cellulosic material such as dried plants from the Plantago family. The application of such conditioners/stabilizers to soil, however, generally requires extensive soil preparation, including tilling the soil, adding the stabilizer, and then tilling the stabilizer into the soil. Being organic, the level of effectiveness of the conditioners/stabilizers further has a diminishing timeline as the elements of nature break down the molecular structures of the cellulosic fibers. An example of this approach is disclosed in Doane, U.S. Pat. No. 7,009,020, which teaches methods of producing starch-graft copolymer granules to mix with fertilizer. Doane further describes the coating of seeds and plant roots with such absorbent granules. Tsujimoto, U.S. Pat. No. 5,930,949, describes methods of hydrating seeds with SAP's prior to germination, however, the SAP particles generally are separated from the seeds before they are planted.

Alternatively, surface water retention nets as described in Matsumoto U.S. Pat. No. 5,601,907 disclose the use of coating applied to a net with a water absorbing resin for the purpose of retaining moisture on the surface of the net. This netting material appears to work well for the purpose of seeding hillsides or rocky areas where vegetation is needed and the soil cannot be properly prepared before planting. However the capability of the net to absorb and retain large amounts of moisture is limited and exposure to the heat of the sun allows a large percentage of moisture to evaporate without aiding in the growth of the vegetation.

Another material, described in Hubbs U.S. Pat. No. 5,746,546, details the use of water absorbent, swellable adhesive particles mixed with textile fibers and aggregate particles. The adhesive particles bind the fibers with the aggregate, providing a surface that has a quick recovery after wet conditions. This method is advantageous in golf course sand traps or athletic fields where it is desirable to have a resilient surface without using large rock or gravel base materials. However, it does not describe a method of retaining moisture to perpetuate vegetation and decrease water usage.

Still further, Kido, U.S. Pat. No. 6,248,444, and Dohrn, U.S. Pat. No. 7,052,775, both describe methods of producing cellulosic fibers, while Saotome U.S. Pat. No. 5,026,596, describes a method of heat-bonding a SAP material to a textile substrate, for forming disposable diapers.

U.S. Pat. No. 6,178,691 teaches the production of a capillary carpet irrigation system. This product, marketed as “Aquamat™,” consists of four layers: a water impermeable base membrane of polyethylene, a water permeable microperforated dark colored top membrane, and two polyester needle punched mats of differing densities. This structure, however, requires a herbicide based root-blocking mechanism to be placed between the plants and the mat, and is not intended for permanent, subterranean installation.

Cargill, U.S. Pat. Publication No. 2005/0118383, discloses a structure having encapsulated SAP granules between multiple layers of textile fabrics. The structure retains large amounts of water and is said to offer benefits due to evaporative cooling. In addition to personal cooling devices, use of the fabric material for fire deterrent blankets also is disclosed.

It therefore can be seen that an economical subterranean geo-textile fabric capable of retaining large amounts of water and releasing it as the soil begins to dry, therefore aiding in the growth of vegetation and decreasing the amount of water required would be desirable. Such a fabric also needs to be durable, environmentally friendly, and have porosity that will not deter plant root growth or the normal transmission of moisture.

### SUMMARY OF THE INVENTION

Briefly described, in one example embodiment, a super absorbent polymer (“SAP”) is extruded into filaments and cut into staple fibers. A composite core yarn strand containing the SAP fibers is then prepared by conventional cotton system spinning methods that could include but are not limited to carded sliver, drawn sliver, roving, rotor spinning, ring spinning, air jet spinning, or friction spinning methods. The composite core yarn strand with SAP fibers is then encapsulated by wrapping a membrane of a defined desired porosity and sealing the composite yarn strand by methods including thermal bonding, adhesive bonding, sonic welding, needle punching or sewing.

An alternative embodiment utilizes a Dref friction spinning system and method to produce the composite textile yarn. A spun core yarn containing the SAP fibers, such as wrapped in a sheath about a core of textile fibers, is fed into the Dref spinning elements in parallel with a membrane substrate that has been slit into a ribbon. When the membrane contacts the spinning drums it is caused to be wrapped/curled at least temporarily around the core yarn. While this temporary state is maintained by the friction of spinning, detached staple fibers are fed at about a ninety degree angle with respect to the membrane-wrapped core yarn structure from the carding unit so as to wrap tangentially around the membrane-wrapped core yarn structure, thus permanently affixing the membrane in a three-dimensional orientation around the core.

In an additional embodiment, super absorbent polymers that have been specially formulated and extruded into fibers so as to resist gel flow as the polymers absorb and/or become saturated with a fluid, such as water, can be utilized within the encapsulated yarns formulated according to the principles of the present invention. These gel flow resistant SAP fibers tend to retain their basic fibrous dimensions through repeated cycles of saturation and desiccation. In this embodiment, the extruded gel flow resistant SAP fibers are blended with conventional staple fibers and generally are formed through nonwoven processes into three-dimensional or similar fabrics. Alternatively, the extruded gel flow resistant SAP fibers can be spun with or without stable fibers into a yarn and then woven, knitted, or tufted or needle-punched with other yarns and/or backing materials into a woven or non-woven fabric, mat or other, similar product. The extruded gel flow resistant SAP fibers also generally do not necessarily require encapsulation as described in the previously cited embodiments, and further generally do not have to be grafted to conventional fibers.

Various objects, features and advantages of the present invention will become apparent to those skilled in the art upon review of the following detailed description, when taken in conjunction with the accompanying drawings.

### BRIEF DESCRIPTION OF THE DRAWINGS

FIG. 1 is an end view of one embodiment of the membrane encapsulated composite yarn according to the principles of the present invention.

FIG. 2 is a side view of the membrane encapsulated composite yarn with spun bonded and/or needle punched fibers.

FIG. 3 is a top plan view of a woven fabric incorporating the membrane encapsulated yarn according to the principles of the present invention.

FIG. 4A is a top plan view of another embodiment of a fabric material including yarns formed from a membrane encapsulated composite yarn according to the principles of the present invention with additional needled fibers attached therewith.

FIG. 4B is a side view of the fabric as illustrated in FIG. 4A.

FIG. 5A is a side view of still another embodiment of a fabric using gel flow resistant SAP yarns according the principles of the present invention, woven with a series of staple fibers.

FIG. 5B is a side view of another embodiment of a fabric formed with the gel flow resistant SAP fibers arranged in an omnidirectional arrangement.

### DETAILED DESCRIPTION OF THE INVENTION

As indicated in FIG. 1, in one preferred embodiment of the present invention, a series of super absorbent polymer (“SAP”) fibers 10 generally having a swell factor of about 250% or greater are formed into a composite core 11 of a yarn strand 12. The SAP fibers selected preferably can be a modified hydrophilic polyacrylate, but also could include any other SAP that could be extruded as a filament such as a hydrolyzed polyacrylonitrate or other, similar polyacrylate material, starch grafted copolymers, cross-linked carbon methylcellulose, or other, similar SAP fibers. The SAP fibers of the core also could include SAP fibers having a greater or lesser swell factor and/or blends or combinations of SAP fibers, depending on the particular application or use desired for a fabric structure formed using the SAP core composite yarn of the present invention. The SAP polymer material is extruded into filaments and cut into staple fibers that can range in length from about 0.05″ to about 2.0″, although other size fibers also can be formed. This fiber is characterized by very low tensile strength and elongation. The composite core yarn strand 12 containing the SAP fibers is formed by blending the SAP fibers with textile fibers 13 in proportions generally ranging from about 20% to about 80% SAP and about 80% to about 20% conventional fibers that could include, but are not limited to, cotton, rayon, flax, jute, knaf, ramie, polyester, polyolefin, polyamide, acrylic, polyethylene, polyactic (“PLA”), and poly (trimethyleneterephthalate) (“PTT”) fibers and/or blends thereof.

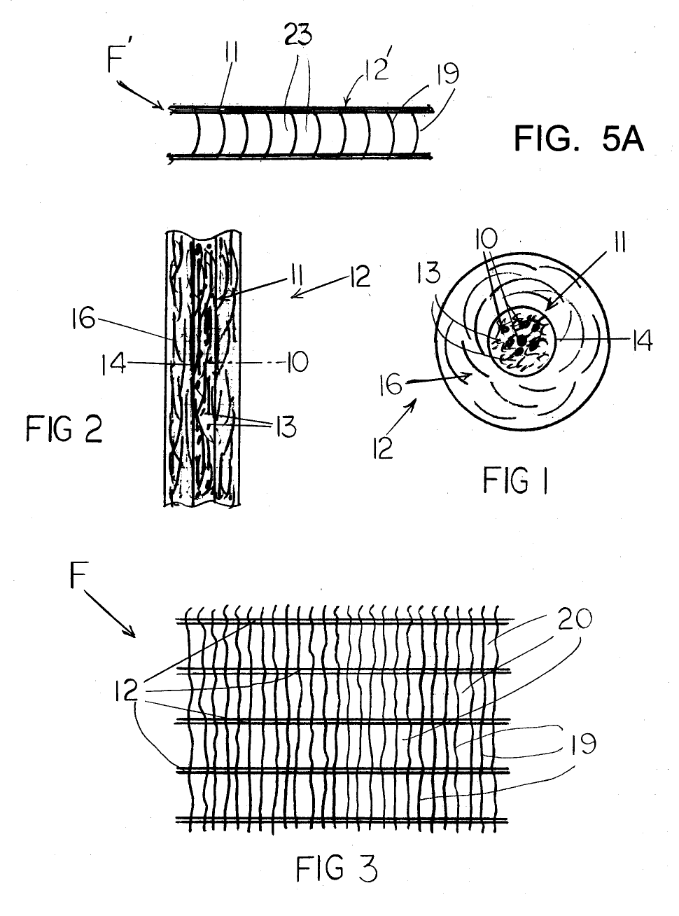

The composite core yarn strand 12 further generally is prepared by conventional cotton system spinning methods that could include, but are not limited to, carded sliver, drawn sliver, roving, rotor spinning, ring spinning, air jet spinning, or friction spinning. The composite core yarn strand is then encapsulated by a membrane 14 generally composed of cotton, rayon, flax, jute, knaf, ramie, polyester, polyolefin, polyamide, acrylic, polyethylene, PLA, PTT, and/or blends thereof, or other similar encapsulating material. Additionally, in some applications as needed, the membrane can comprise a 50%-100% biodegradable material adapted to degrade over time or at a prescribed rate. The membrane typically can include a micro-porous membrane selected as having a defined porosity of typically between about 5 microns to about 220 microns, although greater or lesser porosities also can be used, and generally is sealed about the core strand by one of various sealing/encapsulating methods including thermal bonding, infra-red bonding, adhesive bonding, sonic welding, needle punching, or sewing, such as indicated in FIG. 2.

In an alternative embodiment of the present invention, a composite core yarn containing a hydrophilic polyacrylate or other suitable SAP fiber 10 is formed by intimately blending the SAP fibers in a ratio ranging from approximately 20% to approximately 80% with conventional staple textile fibers, said conventional staple fibers generally including, but are not limited to, cotton, rayon, flax, jute, wool, polyester, polyolefin, polyamide, and/or acrylic fibers and/or blends thereof by a spinning process using the ring, rotor, air jet, or friction methods.

Additionally, strands of staple fibers are prepared for a sheath 16 (FIG. 1) formed about the core 11 and generally can include, but are not limited to, cotton, rayon, flax, knaf, ramie, jute, wool polyester, polyolefin, polyamide, polyethylene, PLA, PTT, and acrylic fibers and/or blends thereof. These sheath fibers 16 generally are fed into the back of a Dref or other spinning machine with the core fibers 11 for spinning together to form the composite spun yarn 12. For example, the present invention can utilize a Dref 3000, Dref 2, 2000 or Dref 3 spinning machine that is capable of producing the desired composite yarns depending upon the yarn size and the fiber lengths utilized. Several strands of the composite yarns further can be fed together to compose a total weight of about 220-400 grains per yard.

As the composite yarn with encapsulated SAP fibers enters the spinning zone of the Dref spinning machine, a carding drum covered with a saw-toothed wire reopens and individualizes the fibers and propels them into the nip or crotch between two perforated drums. The perforated drums are rotated in the same direction at a predetermined rate ranging from 1,500 RPM to 4,000 RPM with an adjustable negative vacuum in the range from about 70 to about 110 millibars being applied at the crotch between the perforated drums where the fibers are received from the carding drum, although greater or lesser pressures also can be used. A membrane ribbon, which generally will comprise from about 5% to about 30% or more of the weight of the entire structure, and can be formed from cotton, rayon, flax, jute, knaf, ramie, polyester, polyolefin, polyamide, acrylics and/or blends thereof or other, similar encapsulating materials, and the core are fed in parallel at one end of the rotating drums and are pulled through the spinning zone of the spinning machine by an outlet roller at the rear of the spinning zone. Additionally, a series of staple sheath fibers also can be fed into the spinning zone for wrapping about the composite yarn core.

As the membrane/SAP fiber yarn structure passes through the spinning zone of the spinning machine, the composite core with SAP fibers is pre-positioned so that the membrane substantially completely encapsulates the core structure, with the sheath 16 of individualized staple fibers additionally being rotated or spun around the membrane, completely covering it to a desired percentage and substantially keeping it from unraveling. The number of strands of the card sliver, the weight per unit length of the core and the composite yarn, and the denier of the core and the yarn can be varied to determine the percentage of membrane, core, and sheath fibers in the overall composite fiber structure.

This process results in a composite yarn structure 12 where the membrane is held in place by the mechanical tension of the outer sheath of staple fibers. It has been demonstrated that this generally will effectively seal the membrane, locking in most of the SAP fibers over repeated absorptive/desorptive cycles. However, because the SAP fibers still could eventually breach the mechanical membrane seal, it is envisioned that an ultrasonic, infra-red, or thermal sealing head also can be mounted at the exit of the Dref spinning zone to thermally seal the membrane by heat or sonic friction. This sealing method has been demonstrated to produce a substantially total and permanent containment of the SAP fibers subject to the permeability characteristics of the membrane material. Alternatively, it also has been envisioned that the utilization of one or more sewing heads or an adhesive applicator also can be used to bond the membrane to the outer sheath, so as to seal the membrane about the core of SAP fibers, either in conjunction with or in place of the ultrasonic or thermal sealing mechanisms. In still other applications, the SAP core and membrane can be spun bonded and/or needle punched with the sheath fibers as shown in FIG. 2 to provide an enhanced open structure for the yarn.

The membrane material utilized in the present invention generally will be selected based upon its having a desired porosity in the range from about 5 to about 200 microns (although other porosities also can be used, depending upon the application for the encapsulated yarns) that permits the transpiration of water freely without allowing the hydrated gel particles of the SAP fibers to escape. The membrane material also generally is very thin and sufficiently pliable to allow the Dref spinning elements to form it around the core without tangling or unduly tearing the membrane material. The membrane material also can include a thermoplastic material to permit sealing via sonic, infra-red, or heat/thermal welding or sealing. Examples of nine polyolefin thermally bonded filtration substrates were acquired having porosity ratings ranging from about 5.0 microns to about 220 microns. Experiments dictated that pretreatment with a liquid synthetic surfactant to negate surface tension present that would inhibit transpiration of water.

The resultant composite yarn structure with encapsulated SAP fibers formed according to the principles of the present invention can be assembled with yarns or filaments 19 of a similar SAP core structure, or alternatively using various natural or synthetic yarns such as cotton, jute, rayon, flax, ramie, knaf, polyesters, polyolefin, acrylic, polyethylene, PLA, PTT, or other materials, formed into an open configuration fabric F, such as shown in FIG. 3, for use such as in sub-soil water retention or geotextile or other, similar applications. This can be done by conventional weaving or knitting techniques or by various nonwoven processes such as heat bonding, needle punching or melt extrusion processes, provided that the assembly process generally leaves an open grid-work having defined open spaces or gaps 20 of between about ⅛″ to about 6″ between the yarn strands, although greater or lesser size spaces also can be used, and capable of allowing excess water and plant roots to pass by the fabric as indicated in FIG. 3. Another configuration could incorporate the present invention into a three dimensional fabric with large diameter fibers in denier ranges generally between about 9 and about 300 denier in a random, omni-directional arrangement, in a repeating, substantially geometric pattern, or on an open grid-work configuration having open spaces of approximately 1/16″-⅛″ up to about 6″ or more therebetween to create a fabric more resilience to soil pressure. This generally will help the membrane coated/covered yarn strands not to become compacted over time and retain a large working area. However, care generally should be taken that soil or sand has to be used to fill in the voids of the fabric to prevent root fungi from developing.

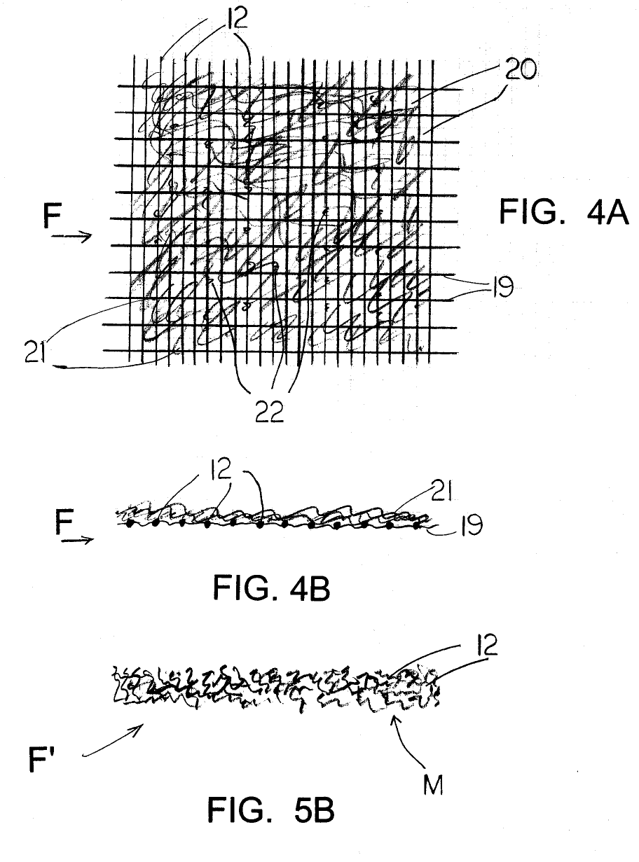

An additional embodiment of fabrics formed using the yarns membrane encapsulated SAP fiber core yarns of the present invention is illustrated in FIGS. 4A-4B. In this embodiment, a woven fabric F, such as shown in FIG. 3, having the composite SAP core yarns of the present invention woven with staple fibers 19 and/or with additional composite core SAP fiber yarns, is needle-punched or tufted with a series of non-woven fibers 21, as indicated at 22 in FIG. 4A. The needle-punched fibers are applied or attached in a substantially omnidirectional arrangement against the open-grid configuration of the fabric F, and can be of an increased denier or size to provide the fabric with additional resilience to soil pressure when used, for example, in a geo-grid or other, similar agricultural or water retention applications.

Preliminary tests reflect the following properties for a fabric formed from the SAP/staple fiber yarn blend formed as discussed above:
The fabric will absorb approximately four times its weight in water while retaining fabric three-dimensional properties.

After drying, the fabric generally will be able to re-hydrate and desiccate through an undetermined number of cycles without undergoing substantial dimensional degradation.
Loss of SAP fibers by weight after multiple wet/dry cycles has been observed to be minimal. For example, after 3 wet/dry cycles of a test fabric utilizing a membrane encapsulated yarn having approximately 28% of a Lanseal® gel flow resistant SAP fiber, further weight loss of the yarn was found to be only approximately 1.5%.
Three-dimensional integrity of the fabric is sustained when fabric is placed under several inches of soil.
The fabric structure is open enough so as not to inhibit root growth and penetration.
Enhancement of turf cultivation utilizing the fabric is being evaluated in current field trials.

The preferred, alternative and additional embodiments of the present invention further are disclosed herein as containing non-biodegradable materials and generally are intended to remain functional in their subterranean environment long term. However, it is anticipated and should be understood that certain applications also could require the structures of the present invention to be fabricated of one hundred percent biodegradable textile materials that would eventually decompose under the ground. The life span and rate of such decomposition could be predetermined by specifying the content of cellulose-based textile fibers utilized in forming the SAP fiber blended yarn structure.

### Trials/Testing

A sample of a Dref-spun composite core yarn made from staple fibers according to the present invention was produced from a modified hydrophilic polyacrylate polymer blended with conventional 3 denier polyester staple fibers. A polyolefin membrane having a porosity of about 120 micron was sonically welded around the composite core yarn utilizing an off-line sonic bonding machine. This yarn then was tested for water absorption and retention in comparison to testing with a similar size strand taken from a conventional Aquamat™ (100% polyester) product.

| | Percent of | Percent of |
|---|---|---|
| | Original Weight | Original Weight |
| | Absorbed | Retained after 8 hours |
| Present Invention | 900% | 532% |
| Aquamat ™ | 706% | 190% |

It can be observed that although the Aquamat™ (100% polyester) takes on a relatively large amount of water initially, a significant amount of the trapped water is not retained over time. This is because the polyester fibers are actually hydrophobic and the water is only temporarily captured within the interstices of the structure. With the present invention, however, the SAP composite core yarn swells and retains a large majority of the water absorbed even after significant time lapse.

In a second series of tests, boxes of sand and topsoil were prepared with composite core yarns of the present invention prepared in accordance with the alternative embodiment discussed above (a Dref spun yarn with a polyacrylate SAP core, 120 micron polyolefin membrane, and staple polyester outer sheath) laid in a matrix form below the surface. Control test boxes were also prepared that: 1) did not contain any matter other than equal amounts of sand and dirt; and 2) had a matrix of 100% cotton yarn of approximately the same weight and configuration as the Dref spun composite SAP yarn.

### Test Apparatus For Sand Box Testing

1. Boxes were fabricated from lexan plastic panels measuring 24×24×12 inches, with a solid bottom sealed to prevent drainage of water from the boxes.
2. Play sand was placed in boxes and leveled to a uniform depth of 3 inches.
3. The sand was allowed to dry until the moisture content was less than 5%.
4. Two 150 watt heat lamps were suspended over each box at a height of 12 inches above the surface.

### Test Method For Sand Box Testing

1. Form a one inch square perpendicular grid of test yarns at a depth of one inch below the surface.
2. Uniformly sprinkle 32.2 ounces of water over the surface of the sand. This is equivalent to about 0.10 inch of rainfall.
3. Burn heat lamps approximately 12 hours per work day.
4. Maintain surface soil temperature of 98°-102° F.
5. Using a Mesdan Moisture Monitor probe, measure the soil moisture content at a depth of one inch, making sure the probe is not in contact with the test yarn. Perform this measurement at the end of the work day before the heat lamps are turned off.
   Results from Testing in Sand Box

| | Day | | | | | | | |
|---|---|---|---|---|---|---|---|---|
| | 1 | 2 | 3 | 4 | 5 | 6 | 7 | 8 |
| TEST | 100% | 75% | 75% | 65% | 55% | 45% | 20% | 35% |
| (Dref Spun | | | | | | | | |
| composite SAP | | | | | | | | |
| Yarn) | | | | | | | | |
| CONTROL | 100% | 45% | 55% | 40% | 28% | 22% | 17% | 32% |
| (No Yarn) | | | | | | | | |

### Test Apparatus For Topsoil Test

1. Prepare back molded plastic trays measuring 18×32×12 inches and having a solid bottom to prevent water drainage were acquired.
2. Play sand was placed in boxes and leveled to a uniform depth of 2 inches.
3. Organic topsoil was sifted three times to homogenize, placed in trays on top of sand, and leveled to a uniform depth of 2 inches.
4. The topsoil was allowed to dry until the moisture content was less than 5%.
5. Two, 150 watt heat lamps were suspended over each tray at a height of 12 inches above the surface.

### Test Method For Topsoil Test

1. Form a one inch square perpendicular grid of test yarns at a depth of one inch below the surface.
2. Uniformly sprinkle 53.57 ounces of water over the surface of the topsoil. This is equivalent to about 0.25 inch of rainfall
3. Burn heat lamps approximately 12 hours per work day.
4. Maintain surface soil temperature of 98°-102° F.
5. Using a Mesdan Moisture Monitor probe, measure the soil moisture content at a depth of one inch, making sure the probe is not in contact with the test yarn. Perform this measurement at the end of the work day before the heat lamps are turned off.

### Results Comparing Water Retention in Topsoil Containing Invention Versus Plain Topsoil

| | Day | | | | | | | | |
|---|---|---|---|---|---|---|---|---|---|
| | 1 | 2 | 3 | 4 | 5 | 6 | 7 | 8 | 9 |
| TEST | 100% | 100% | 75% | 98% | 25% | 35% | 35% | 36% | 25% |
| (Dref Spun | | | | | | | | | |
| composite SAP | | | | | | | | | |
| Yarn) | | | | | | | | | |
| CONTROL | 95% | 60% | 60% | 50% | 11% | 8% | 9% | 1% | 2% |
| (No Yarn) | | | | | | | | | |

### Results Comparing Water Retention in Topsoil Containing Present Invention Versus Topsoil Containing Absorbent Cotton Yarn

| | Day | | | | | |
|---|---|---|---|---|---|---|
| | 1 | 2 | 3 | 4 | 5 | 6 |
| TEST | 60% | 50% | 35% | 30% | 24% | 25% |
| (Dref Spun | | | | | | |
| composite SAP | | | | | | |
| Yarn) | | | | | | |
| CONTROL | 25% | 25% | 7% | 17% | 8% | 12% |
| (Cotton Yarn) | | | | | | |

An additional embodiment of the present invention, such as shown in FIGS. 5A-5B, relates to the utilization of fibers extruded from super absorbent polymers (SAP's) that have been treated so as to substantially resist gel flow of the SAP fibers when absorbing or becoming saturated with a fluid such as water, thereby reducing or potentially eliminating the need for encapsulation of the SAP fibers by a membrane or sheath of additional fibers. The extruded gel flow resistant SAP fibers of this embodiment generally are intimately blended with conventional staple fibers 19 to form a composite yarn 12′ without any encapsulating membrane. These non-encapsulated composite yarns 12′ can then be combined with additional yarns or fibers 19 and formed through nonwoven processes into three-dimensional fabrics F′ (FIG. 4A) having open spaces 23 of approximately 1/16″ up to approximately 6″ or more. Alternatively, the extruded gel flow resistant SAP fibers can be first spun into a yarn (including with additional staple fibers as needed), and then woven, knitted, or tufted into fabric. Still further, as illustrated in FIG. 4B, the gel flow resistant SAP fibers can be blended or intermixed together and/or with a series of staple fibers in a substantially random, omnidirectional arrangement to form a fabric mat M. Such a fabric mat can be formed in varied thicknesses and can include staple fibers of varying sizes or deniers and/or with other desired material properties so as to provide enhanced resiliency to the fabric mat to resist compaction from soil such as when used in geo-textile or other, similar water retention applications.

An example of the present additional embodiment was produced with gel flow resistant SAP fibers supplied by Toybo of Japan under the tradename “Lanseal F®.” In this example, illustrated in FIG. 4, a series of extruded Lanseal F® gel flow resistant SAP fibers were blended at 20% with 80% of a conventional 1.8 denier per filament polypropylene fiber cut to a staple length of about 38 mm and intimately blended with a yarn. It also will be understood that additional types of staple fibers, such as cotton, rayon, flax, knaf, ramie, jute, wool, polyester, polyolefin, polyamide, polyethylene, PLA, PTT, and/or acrylic fibers and/or blends thereof, as discussed above, also can be blended with the extruded gel flow resistant SAP fibers of the present embodiment. The blend was processed into a 6/1 Ne yarn intimate blend with the staple and SAP fibers, and without an encapsulating membrane applied thereabout, through conventional cotton system carding, drawing, and rotor spinning operations. The 6/1 Ne Lanseal® blend yarn was then knitted into a three-dimensional fabric having a structure as illustrated in FIG. 3 on a double needle bar raschel warp knitting machine under the following parameters:

| | |
|---|---|
| Machine | Muller GWM 1200 mm double needle bar raschel |
| Gauge | 4/cm |
| Stitch Density | 5/cm |
| Fabric Weight | 579 grams per square yard |
| Speed | 150 RPM |
| Delivery Rate | 22.62 square yards per hour |
| Yarn 1 | 5 feeds, 120 denier polyester monofilament, |
| (indicated at 19) | 40% of weight |
| Yarn 2 | 1 feed, 6/1 Ne 80% polypropylene/20% |
| (indicated at 12) | Lanseal ® 60% of weight |

### Trials/Testing

Testing was conducted utilizing the geo-grid fabric described above, having a membrane encapsulated core yarn including Superabsorbent Polymer Fibers, which had been further treated to resist gel flow of the SAP fibers when absorbing or become saturated with a fluid according to the principles of the present invention. The test was conducted as follows:

### Test Apparatus

1. 2 testing Boxes were fabricated from lexan plastic panels measuring 24×24×12 inches with a solid bottom so that no water could drain from the test apparatus.
2. Play sand was placed in the boxes to a uniform depth of 3 inches.
3. The sand was allowed to dry until moisture content as measured in each of the test apparatus was less than 5%.
4. Potting soil was then added to a uniform depth of 6 inches.
5. The potting soil was allowed to dry until moisture content as measured in each test apparatus was less than 5%.
6. A 3-dimensional geo-grid fabric, as discussed with respect to the embodiment shown and FIG. 3, and comprising up to approximately 20% Lanseal® SAP fibers was placed on top of the potting soil, completely covering the potting soil, in one test box. The other test box remained as a control with no geo-grid materials.
7. An additional ½ inch of top soil was then added to both the invention and control test boxes, covering the geo-grid material of the invention test box.
8. Fescue sod was then placed in both test boxes covering all exposed dirt areas.

### Test Method

1. The test boxes were then placed in full exposure of sun, rain and all natural elements in an outdoor environment.
2. Moisture readings were attained daily each afternoon for 110 days. All added water, either naturally or by sprinklers was logged and recorded.
3. Moisture percentages were measured for the control and invention test boxes as follows:
   (a) ¼ inch below the surface—immediately below the root mass of the transplanted fescue sod.
   (b) 1 inch beneath surface—at a level aligned with the top of the 3-dimensional fabric;
   (c) 2 inches below the surface—at a level immediately beneath the 3-dimensional fabric; and
   (d) 10 inches beneath surface—taken at the bottom surface of the Lexan invention and control test boxes.

### Test Results

The control test box (without the 3-dimensional geo-grid fabric) was found to require approximately 40% more water to be added during the life of the testing to maintain an equivalent amount of moisture within the control box as was maintained within the invention test box including the 3-dimensional fabric formed utilizing the membrane encapsulated composite yarn according to the principles of the present invention.

Conclusions from Testing

It can be readily observed from the presented testing that the invention, represented as the invention test sample, caused the sand and the topsoil to retain significantly more water than the control samples containing no yarn. Likewise, the topsoil containing the composite SAP core yarns and/or geo-grid fabrics with gel flow resistant SAP core yarns retained significantly more water than the soil containing a conventional cotton absorbent yarn. It also will be understood that composite SAP yarn of the present invention further can be woven, knitted or otherwise formed into a fabric structure having an open configuration with defined spaces or voids, or can be formed with a strand arranged in a substantially random configuration. When used as a subterranean fabric structure or material, the resultant fabric structure substantially retains moisture while permitting normal root growth and allowing excess water to pass through and beneath the fabric and facilitating movement of collected water from lower levels of the plant root structure toward the surface of the soil.

It will be further understood by those skilled in the art that while the present invention has been described above with reference to preferred embodiments, numerous variations, modifications, and additions can be made thereto without departing from the spirit and scope of the present invention as set forth in the following claims.

1. A composite yarn comprising of a core of a plurality of super absorbent polymer fibers encased in a micro-porous membrane having a pre-defined porosity, wherein the membrane is substantially sealed about the core sufficient to encapsulate and deter migration of the super absorbent fibers from the core upon absorption of a fluid thereby.

2. The yarn of claim 1, and wherein the super absorbent polymer fibers comprise starch grafted copolymers, cross-linked carboxymethylcellulose, hydrolyzed polyacrylonitrate polymers, modified hydrophilic polyacrylate polymers, or combinations thereof.

3. The yarn of claim 1, and wherein the membrane has a porosity of between about 5 and about 220 microns.

4. The yarn of claim 1 and wherein the core further comprises a plurality of staple fibers spun with the super absorbent polymer fibers.

5. The yarn of claim 1 and further comprising a sheath of staple fibers applied about the membrane.

6. The yarn of claim 1, and wherein the membrane is sealed about the core by ultrasonic bonding, thermal bonding, infra-red bonding, sewing, sonic welding, needle punching or application of an adhesive.

7. The yarn of claim 1, and wherein the membrane comprises cotton, rayon, flax, jute, knaf, ramie, polyester, polyolefin, polyamide, acrylic, polyethylene, PLA, PTT, or combinations thereof.

8. The yarn of claim 1, and wherein the core and membrane comprise 100% biodegradable materials.

9. The yarn of claim 1 and wherein the super absorbent polymer fibers comprise gel flow resistant super absorbent polymer fibers.

10. A fabric constructed from the yarn of claim 1 and comprising a substantially open configuration including open spaces defined between the yarns of the fabric, wherein the open spaces have an approximate opening size in a range of about ⅛″ to about 6″.

11. The fabric of claim 10, and wherein placement of the yarns in the fabric is substantially random and omnidirectional.

12. The fabric of claim 10, and wherein the yarns of the fabric are knitted to form the fabric and the open spaces of the fabric are formed in a repeating geometric pattern.

13. An absorbent yarn comprising a core of super absorbent polymer fibers and a membrane having a defined porosity and encapsulating said core, wherein said membrane is substantially sealed about said super absorbent fibers of said core and said core is wrapped with an outer sheath of hydrophilic fibers.

14. The yarn of claim 13, wherein said super absorbent polymer fibers comprise starch grafted copolymers, cross-linked carboxymethylcellulose, modified hydrophilic polyacrylate, polymers, gel flow resistant polymers, or blends thereof.

15. The yarn of claim 13, wherein said membrane comprises a non-woven membrane having a porosity of between about 5 and about 200 microns.

16. The yarn of claim 13, wherein said membrane and core are sealed by ultrasonic bonding, thermal bonding, infra-red bonding, sewing, sonic welding, or adhesive.

17. The yarn of claim 13, wherein said membrane comprises cotton, rayon, flax, jute, knaf, ramie, polyester, polyolefin, polyamide, acrylic, polyethylene, PLA, PTT, or blends thereof.

18. The yarn of claim 13 and wherein said super absorbent polymer fibers have a swell factor of up to approximately 250%.

19. An absorbent fabric comprising a series of yarns, at least a portion of the yarns including a plurality of stable fibers blended with a series of fibers formed from gel flow resistant super absorbent polymers, wherein said gel flow resistant super absorbent polymer fibers do not require encapsulation within or grafting to said staple fibers.

20. The fabric of claim 19 formed into a three dimensional structure by weaving, warp knitting, weft knitting, and/or tufting.

21. The fabric of claim 19, wherein said staple fibers of said yarns comprise cotton, rayon, flax, jute, knaf, ramie, polyester, polyolefin, polyamide, acrylic, polyethylene, PLA, PTT, or blends thereof.

22. An absorbent and fluid retention fabric formed by a nonwoven process including air-laid, needle punching, spun laced, and/or a spun-bonding, and comprising a plurality of staple fibers blended with a series of gel flow resistant super absorbent polymer fibers, wherein the gel flow resistant super absorbent polymer fibers do not require encapsulation within or grafting to the staple fibers.
